(19) United States
(12) Patent Application Publication
(10) Pub. No.: US 2003/0105618 A1
(43) Pub. Date: Jun. 5, 2003

(54) Diagnostic method for correctly handling discontinuities during circuit simulation or mixed-signal simulation

(76) Inventor: Diana Estevez-Schwarz, Berlin (DE)

Correspondence Address: LERNER AND GREENBERG, P.A., Post Office Box 2480, Hollywood, FL, 33022-2480, US

(21) Appl. No.: 10/310,443

(22) Filed: Dec. 5, 2002

(30) Foreign Application Priority Data
Dec. 5, 2001 (DE) 101 59 548.4

(51) Int. Cl. G06F 17/50

(52) U.S. Cl. 703/14

(57) ABSTRACT

An image is used to diagnose an electric circuit having a multiplicity of elements. The image includes a network graph and a system of equations. The network graph contains dynamic elements for which voltage values can be preset. In order to handle such defaults correctly, statements are made to indicate the dynamic elements for which no values can be preset, and a subsidiary network graph is established in which the dynamic elements of the network graph are replaced by suitable current sources and by voltage sources. A DC-solvable system of equations is produced using the information from the network graph thus modified. The solution of the system of equations thus obtained corresponds to the defaults for the initial value of the original system.

### BACKGROUND OF THE INVENTION

1. Field of the Invention

The invention relates to a diagnostic method for the correct handling of discontinuities during circuit simulation or mixed-signal simulation.

The behavior of electric circuits is described by a system of differential equations in the context of simulation. Such systems of differential equations exhibit discontinuities that can occur, for example, as a result of switching digital signals during mixed-signal simulation. In this context, a user, for example, can preset values for individual variables of the simulated electric circuit at precisely defined instants. Such values are applied irrespective of the previous behavior of the simulated components or the simulated electric circuit.

At such instants of discontinuity, the problem of defining an initial value arises for the differential equations. The calculation of a suitable initial value in such a system of differential equations requires defaults that do not result in an insolvable system of equations.

If the defaults are consistent, a uniquely solvable system of equations is set up and new initial values are calculated for the further simulation of the electric circuit under consideration.

Using the so-called “weak formulation” method, each user presetting for a component is reformulated in such a way that it is initially consistent. In practice, this procedure leads to the calculation of a somewhat “disturbed” initial value.

For circuits that do not contain any inductors, a direct-current system of equations can be considered, for example, for calculating the initial value. The system is constructed in such a way that all of the capacitors of the network graph are replaced by voltage sources with small serial resistors. Current sources are added in parallel with the voltage sources, and inject the value of the current that flowed through the capacitor before the instant of discontinuity.

In this way, the voltage sources with preset values that replace capacitors with preset values are given the required value. Voltage sources that replace capacitors without preset values are given the value of the branch voltage that was present across the capacitor before the instant of discontinuity.

The addition of the resistors allows all of the defaults to be implemented without the occurrence of insolvable systems of equations. The values obtained in this way correspond to the defaults only approximately, depending on the size of the resistors.

In a second step of this method, by examining threshold values, the inserted resistors are reduced to such low values that the error is sufficiently small. The disadvantage in this is that the threshold value examinations are not always possible and the results are not necessarily consistent.

### SUMMARY OF THE INVENTION

It is accordingly an object of the invention to provide a diagnostic method for correctly handling discontinuities during circuit simulation or mixed-signal simulation which overcomes the above-mentioned disadvantages of the prior art methods of this general type.

In particular, the invention addresses the problem of providing a method in which inconsistent defaults for values relating to individual components of the electric circuit are reliably detected during simulation. The invention also addresses the problem of providing a method in which a uniquely solvable system of equations for calculating a suitable initial value can be set up directly.

With the foregoing and other objects in view there is provided, in accordance with the invention, a diagnostic method for correctly handling discontinuities during circuit simulation or mixed-signal simulation. The method includes steps of: obtaining an image of an electronic circuit including a plurality of elements wherein the image exists both as a network graph and as a system of differential algebraic equations taking a form of F(x′,x,t)=0, wherein values for voltages present across specific capacitors in the image can be preset, and wherein a further graph can be formed using information from the network graph; viewing the image at an instant of discontinuity; forming the further graph to include all branches of voltage sources of the network graph; successively adding to the further graph a branch of each capacitor in the network graph for which a branch voltage is preset; checking each capacitor to ascertain whether the branch of the capacitor closes a loop in the further graph and if so flagging the capacitor; successively adding to the further graph a branch of each capacitor in the network graph for which no branch voltage is preset; checking each capacitor for which no branch voltage is preset to ascertain whether the branch of the capacitor for which no branch voltage is preset closes a loop in the further graph, and if so, flagging the capacitor for which no branch voltage is preset; checking whether a capacitor is flagged for which a branch voltage has been preset, and if so, outputting an error message; replacing each unflagged capacitor, for which a value is preset, by a voltage source for injecting the value that is preset and by a current source configured in parallel with the voltage source, the current source for injecting a value of a current flowing through the unflagged capacitor before the instant of the discontinuity; replacing each unflagged capacitor, for which a value is not preset, by a voltage source for injecting a value of a branch voltage present before the instant of the discontinuity and by a parallel configured current source for injecting a value of a current flowing through the unflagged capacitor, for which a value is not preset, before the instant of the discontinuity; replacing each flagged capacitor by a current source for injecting a value of a current flowing through the flagged capacitor before the instant of discontinuity; obtaining solution values by setting up and solving DC equations for the further graph; and transferring the solution values to the network graph.

With the foregoing and other objects in view there is provided, in accordance with the invention, a set of computer-executable instructions for performing the above-described diagnostic method for correctly handling discontinuities during circuit simulation or mixed-signal simulation.

With the foregoing and other objects in view there is provided, in accordance with the invention, a computer-readable medium having computer-executable instructions for performing the above-described diagnostic method for correctly handling discontinuities during circuit simulation or mixed-signal simulation.

In accordance with an added feature of the invention, the computer-readable medium is a storage medium.

In accordance with an additional feature of the invention, the computer-readable medium is a computer memory.

In accordance with another feature of the invention, the computer-readable medium is a random-access memory.

In accordance with a further feature of the invention, the computer-readable medium is an electrically transmitted carrier signal.

With the foregoing and other objects in view there is provided, in accordance with the invention, a process which comprises downloading, from an electronic data network to a computer connected to the data network, a set of computer-executable instructions for performing the above-described diagnostic method for correctly handling discontinuities during circuit simulation or mixed-signal simulation.

In accordance with yet an added feature of the invention, the data network is an Internet.

In accordance with the invention, an electric circuit including a plurality of elements is examined. An image of this electric circuit exists on a computer system for the purpose of diagnosing it.

In this way, the actual electric circuit is initially represented as a network graph on the computer system. In this network, the individual elements are represented by graphical symbols and the interconnection of the elements is represented by connecting lines. Using the information from this network graph, a system of differential algebraic equations is set up in the form:

F(x′,x,t)=0.

This system of differential algebraic equations describes the behavior of the simulated electric circuit by representing the physical relationships of the unknowns in the electric circuits being examined.

For dynamic elements of the network graph, including capacitors and inductors, values can be preset by a user, particularly voltage values and current values.

During simulation of the electric circuit with a system of differential algebraic equations, discontinuities occur due to the presetting of such values, thereby creating the problem of determining an initial value for the system of differential algebraic equations resulting therefrom.

In this invention, the image of an electric circuit is examined at such an instant of discontinuity. In the following inventive method, the voltage values and current values assumed before the instant of discontinuity are presumably known.

The problem is illustrated below by examining defaults for the branch voltages of capacitors. Discontinuities in currents through inductors can be handled in two ways. For the sake of simplicity, the following disclosure examines networks that do not contain any inductors. If a circuit contains both capacitors and inductors, then it is also important in the following considerations to ensure that the overall resulting DC or direct-current system of equations is solvable.

In a first step of the method, all of the linear independent loops of the network graph are determined. The loops have either exclusively capacitors or both capacitors and voltage sources, and one capacitor per linear independent loop of this type is flagged. According to Kirchhoff's loop law, loops containing exclusively voltage sources cannot occur. It is therefore possible to flag a capacitor in each of these linear independent loops.

For this purpose, a further graph is successively created on the basis of an existing network graph.

This graph is produced by initially adding all of the branches of voltage sources in the existing network graph to this graph. In accordance with Kirchhoff's loop law, the graph constructed in this way does not contain any loops.

Next, the branches of the capacitors are individually added to this graph, with a distinction being made between those capacitors for which branch voltages will be preset and those capacitors for which no branch voltages will be preset.

First, the branches of those capacitors for which branch voltages will be preset are successively added to the graph. At the same time, each capacitor is checked to ascertain whether the branch closes a loop in the graph. If this is the case, the capacitor is flagged.

The closing of a loop is understood to mean the detection of a closed path from one node of the branch to the other node of the branch. This is the case if a related subgraph of the previously created graph touches the branch at both nodes.

Next, the branches of those capacitors for which no branch voltages will be preset are successively added to the graph. At the same time, these capacitors are also checked to ascertain whether the branch of a capacitor closes a loop in the graph. If this is the case, the capacitor is flagged.

Because of this sequence, the capacitors for which branch voltages will be preset are flagged only if this is unavoidable.

In a next step, a check is performed to ascertain whether a capacitor has been flagged for which the branch voltage will be preset. If so, the defaults are not consistent. In this case, an error message is output and the method is terminated at this point.

As a result, a new graph is created. This is initially an image of the original graph, which is then modified as follows. Those unflagged capacitors for which values are preset are replaced by voltage sources that inject the preset value. Current sources are added in parallel to the voltage sources, and inject the value of the current that flowed through the capacitor before the instant of discontinuity.

Those unflagged capacitors for which no values are preset are replaced by voltage sources that inject the value of the branch voltage that was present before the instant of discontinuity. Current sources are added in parallel with the voltage sources, and inject the value of the current that flowed through the capacitor before the instant of discontinuity.

The flagged capacitors are only replaced by current sources which inject the value of the current that flowed through the capacitor before the instant of discontinuity.

The sequence of capacitors is irrelevant during this substitution. The unflagged capacitors for which values are preset, the unflagged capacitors for which no values are preset, and the flagged capacitors can be replaced in any desired sequence by current sources and/or voltage sources.

The next step according to the invention is to set up and solve the DC equations of the network graph thus obtained. This is known to the person skilled in the art.

The solution values thus obtained are transferred to the original network graph. These values correspond to the defaults and satisfy the equations of the system. Using these solution values, it is possible to find a permissible solution for the network graph at the instant of discontinuity.

Using this solution for the network graph at the instant of discontinuity, the subsequent simulation can be performed more effectively.

According to a fundamental idea of the invention, a method based on graph theory is used to diagnose electric circuits. The method allows the display and local avoidance of configurations that are critical in terms of solvability.

The procedure used in the known methods to handle points of discontinuity attempts globally to avoid the solvability problems of the differential equation problem by adding serial resistors. This procedure does not guarantee coherence and accuracy. By contrast, using methods based on graph theory according to the invention allows direct and correct handling.

The network graphs that are created or modified by the inventive method can be represented by solvable systems of equations. The solution of the system of equations thus obtained corresponds to the defaults for the initial value of the original system.

It should also be noted that those solutions calculated using the existing or the novel procedure are consistent in the sense that they satisfy the Kirchhoff equations. However, they are not necessarily consistent initial values in the sense of the differential algebraic systems. In order to obtain a value that is consistent in the sense of the differential algebraic systems, it is possible thereupon to use the algorithm described in Estévez Schwarz, D.: CONSISTENT INITIALIZATION FOR DIFFERENTIAL ALGEBRAIC EQUATIONS AND ITS APPLICATION TO CIRCUIT SIMULATION; Department of Mathematics, Humboldt University, Berlin, PhD Thesis (2000), which is hereinafter referenced by [1]. A copy of this document is available at: http:\\dochost.rz.hu-berlin.de/dissertationen.

This method reliably identifies capacitors for which no voltage values must be preset. Inconsistent defaults can therefore be modified on the basis of these results. The user therefore has the opportunity to eliminate errors specifically.

According to a further idea of the invention, discontinuities in currents through inductors can be handled in two ways.

When considering inductors, value defaults for the flowing current are examined in particular. Instead of examining loops of only capacitors and/or voltage sources, as when handling discontinuities in capacitor voltages, subsets of only inductors and/or current sources are examined here.

In this case, it is not possible to preset the current for an inductor for each linearly independent subset of only inductors and/or current sources.

If a circuit contains both capacitors and inductors, then it must additionally be ensured when executing the method according to the invention that the overall resulting direct current system of equations is solvable.

Circuits can also contain controlled sources. These controlled voltage sources can occur as current-controlled and/or voltage-controlled voltage sources and/or as current-controlled and/or voltage-controlled current sources.

The inventive method can only be applied to circuits whose controlled sources satisfy certain preconditions. The permissible sources for the method are grouped into classes of allowable controlled sources with regard to the possibility of making statements about the “differential algebraic equations” index or “DAE index”.

Document [1] cited above contains a description of the allowable controlled sources for which the inventive method can be carried out.

The article Estévez Schwarz, D., Tischendorf, C.: STRUCTURAL ANALYSIS OF ELECTRIC CIRCUITS AND CONSEQUENCES FOR MNA; Int. J. Circ. Theor. Appl. 28 (2000), pp. 131-162, also contains a description of the allowable controlled sources for which the inventive method can be carried out. This article will be hereinafter referenced by [2].

If a circuit contains controlled sources that do not correspond to these classes, then regularization proposals can be specified using algorithms based on graph theory, which proposals allow the controlled sources to be handled.

The examinations of the invention that are based on graph theory are also implemented in a computer program for executing a diagnostic method for the correct handling of discontinuities during circuit simulation or mixed-signal simulation.

The computer program is configured in such a way in this case that, after the image of the electric circuit has been entered, the examinations based on graph theory and included in the inventive method can be performed in an embodiment as described above.

In this way, as a result of the method, it is possible to make a statement as to whether values preset by the user are possible for individual dynamic components of the electric circuit. The corresponding equations for calculating suitable values are set up in a computer program constructed thereupon.

Using the method implemented on the computer system, it is easy to change the defaults for individual dynamic components of the electric circuit.

Using the improved computer program results in an improved applicability of the method for a multiplicity of electric circuits, with simple and effective recognition of non-permissible user presettings.

The invention also relates to a computer program that is contained on a storage medium, is filed in a computer memory, is contained in a random access memory, or is transmitted on an electric carrier signal.

The invention also relates to a data medium with such a computer program and to a method in which such a computer program is downloaded from an electric data network, the Internet for example, onto a computer that is connected to the data network.

Other features which are considered as characteristic for the invention are set forth in the appended claims.

Although the invention is illustrated and described herein as embodied in a diagnostic method for correctly handling discontinuities during circuit simulation or mixed-signal simulation, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a flowchart of the diagnostic method for correctly handling discontinuities during circuit simulation or mixed-signal simulation;

FIG. 2 is a schematic diagram of an exemplary embodiment of an electric circuit; and

FIG. 3 is a schematic diagram of an exemplary embodiment of a modified electric circuit.

### DESCRIPTION OF THE PREFERRED EMBODIMENTS

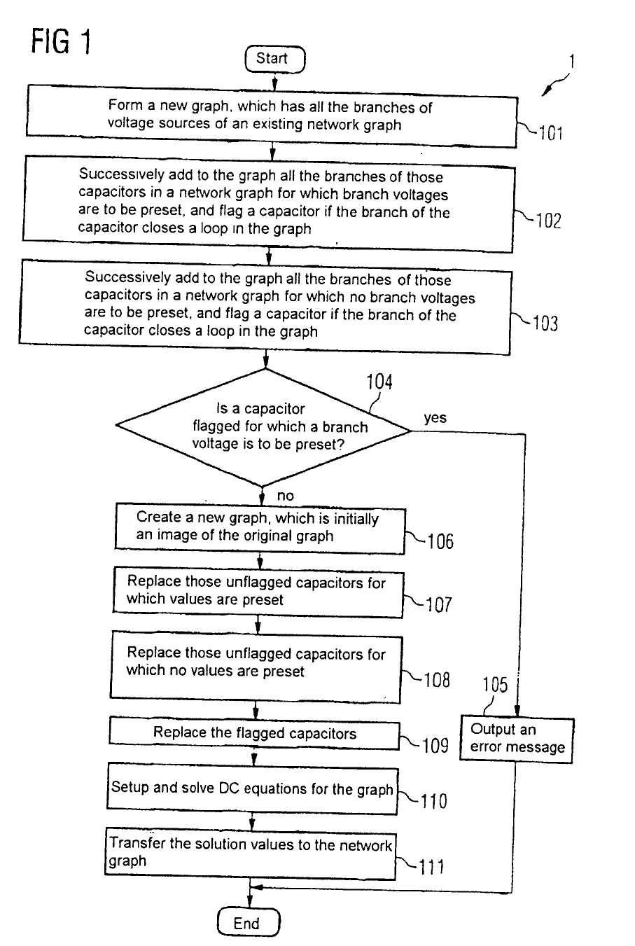

Referring now to the figures of the drawing in detail and first, particularly, to FIG. 1 thereof, there is shown a flowchart 1 of the diagnostic method for correctly handling discontinuities during circuit simulation or mixed-signal simulation.

The flowchart is divided into a start box, eleven method steps 101 to 111 and an end box.

The method is used to examine a real electric circuit having a multiplicity of elements. The image of this real electric circuit is present in the form of a network graph and in the form of a system of differential algebraic equations.

Such a network graph illustrates the real elements of the underlying electric system using graphical symbols and the interconnection of these components using connecting lines. A typical network graph of a NAND gate is included on page 75 of document [1].

By applying Kirchhoff's laws and by applying current relationships and voltage relationships to the network elements, in particular at nodes of the network, it is possible to set up a system of differential algebraic equations that describes the behavior of the underlying electric circuit. The Kirchhoff nodal equations state that, for each network node, the sum of all inflowing currents equals the sum of the outflowing currents.

These differential algebraic equations contain parameters, in particular the time t, and unknowns, in particular, flows, charges, currents and voltages, and their derivatives. Pages 119-120 of document [1] includes the system of differential algebraic equations for describing the NAND gate described by a network graph in document [1] on page 75.

Systems of differential algebraic equations can exhibit discontinuities that are caused by, for example, the switching of digital signals or by the value presettings of the user for dynamic elements, i.e. for capacitors and inductors.

In the examples treated here, voltage values are preset for specific capacitors at a defined instant. These voltage values are applied to the selected capacitor in the image of the real electric circuit at a defined instant, irrespective of the previous behavior or of the previous voltage value of the capacitor in question.

The diagnostic method for correctly handling discontinuities during circuit simulation or mixed-signal simulation assumes a network graph of a real electric circuit, and examines the system of equations that can be derived from the network graph. The system describes the underlying electric circuit, at such an instant of discontinuity.

The voltage values and current values present at the individual elements before this instant of discontinuity are presumably known.

The flowchart illustrated in FIG. 1 shows the individual method steps using boxes, and the sequence of the method steps is indicated using arrows. Decision boxes are shown using diamonds. Method steps that will be executed in the image of the electric circuit are shown by rectangles.

In accordance with a first method step 101, a new graph is formed, which includes all of the branches of voltage sources from an existing network graph.

A second method step 102 includes the successive addition to the graph of all the branches of those capacitors in a network graph for which branch voltages will be preset. At the same time, a capacitor is flagged if the branch of the capacitor closes a loop in the graph.

This is followed by a third method step 103, which includes the successive addition to the graph of all those branches of those capacitors in a network graph for which no branch voltages will be preset. At the same time, a capacitor is flagged if the branch of the capacitor closes a loop in the graph.

The subsequent fourth method step 104 is shown as a diamond in FIG. 1 and represents a decision box. This fourth method step 104 checks whether a capacitor is flagged for which a branch voltage will be preset.

If this is the case, an error message is output in a fifth method step 105 and the method is then terminated.

If no flagged capacitor is detected for which a branch voltage is to be preset, the method continues with the sixth method step 106. In the sixth method step 106 a new network graph is established which is initially an image of the original network graph. The following replacements are then carried out:

In the seventh method step 107, those unflagged capacitors for which values are preset are replaced. In this step, the capacitors are replaced by voltage sources that inject the preset value and by current sources that are arranged in parallel therewith and inject the value of the current flowing through the capacitor before the instant of discontinuity.

An eighth method step 108 following thereupon provides for replacing those unflagged capacitors for which no values are preset by voltage sources for injecting the value of the branch voltage present before the instant of discontinuity, and by current sources arranged in parallel for injecting the value of the current flowing through the capacitor before the instant of discontinuity.

In accordance with a ninth method step 109, the flagged capacitors are replaced, specifically by current sources that inject the value of the current flowing through the capacitor before the instant of discontinuity.

In a tenth method step 110, DC equations are set up on the basis of the graph determined in the method steps previously carried out. These DC equations are then solved using methods known to the person skilled in the art.

These solution values are transferred to the original network graph in an eleventh method step 111.

An essential feature of the method as described by the flowchart 1 shown in FIG. 1 is that voltages can be preset for all capacitors in the network with the exception of one capacitor per linearly independent loop, which includes only capacitors and/or voltage sources.

If voltages are preset for all the capacitors in such a loop, or if a voltage is preset for the only capacitor present, then these defaults are not consistent. This results in a detailed error message with the description of the loop. On the basis of this error message, the user can change the defaults in such a way that they are consistent.

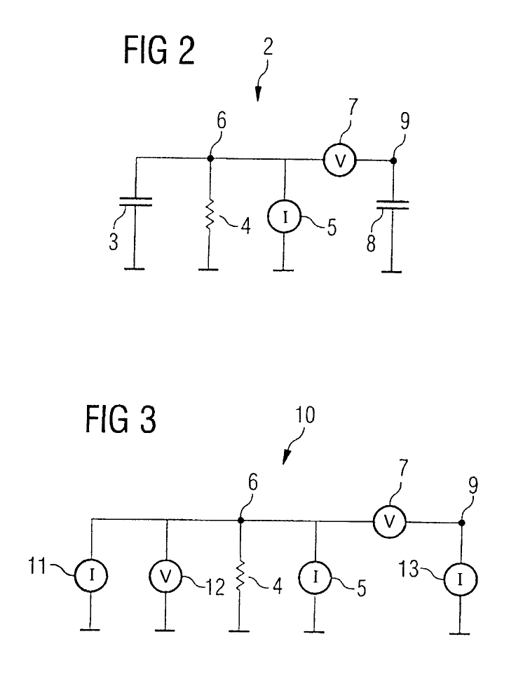

FIG. 2 shows a schematic diagram of an example of an electric circuit 2.

The electric circuit 2 includes a first capacitor 3, an ohmic resistor 4, a first current source 5, a first node 6, a first voltage source 7, a second capacitor 8 and a second node 9.

In the present example, precisely one loop of the electric circuit 2 is relevant to illustrate the method. This loop includes the first capacitor 3, the first voltage source 7 and the second capacitor 8. The first node 6 and the second node 9 are arranged on this loop in FIG. 2.

In the present example, a value is preset for the voltage of the first capacitor 3.

A system of equations can be derived from the electric circuit 2 shown in FIG. 2.

If the charge-oriented “MNA” (Modified Nodal Analysis) is used, then this system of equations is as follows:

q′₁+r(e₁)+i(t)+jᵥ+0

+jᵥ+q′₂+0

e₁+e₂+v(t)

q₁+q_{c1}(e₁)

q₂+q_{c2}(e₂)

In the above, q₁ represents the charge of the first capacitor 3, q₂ the charge of the second capacitor 8, e₁ the node potential of the first node 6, e₂ the node potential of the second node 9, r(e₁) the current through the ohmic resistor 4, v(t) the characteristic function of the first voltage source 7, jᵥ the current through the first voltage source 7, and i(t) the current through the first current source 5.

By examining the loop including the first capacitor 3, the first voltage source 7 and the second capacitor 8, it is easy to see that the second capacitor 8 is flagged by the method.

FIG. 3 shows a schematic diagram of a modified electric circuit 10.

The modified electric circuit 10 includes the ohmic resistor 4, the first current source 5, the first voltage source 7, a second current source 11, a second voltage source 12, a third current source 13, the first node 6, and the second node 9.

The modified electric circuit 10 corresponds to the electric circuit 2 shown in FIG. 2, but differs in that the first capacitor 3 is replaced by the second current source 11 and by the second voltage source 12, which is connected in parallel therewith, and in that the second capacitor 8 is replaced by the third current source 13.

On the basis of the modified electric circuit 10, the “MNA” can be used to derive the following system of equations for describing the modified electric circuit 10:

i_{C1old}+j_{VC1}r(e₁)+i(t)+j_{V}+0

+j_{V}+i_{C2old}+0

e₁+e₂+v(t)

e₁=V₁.

In the above, I_{C1old} is the value of the current of the second current source 11. This corresponds to the value of the current that flowed through the first capacitor 3 before the instant of discontinuity. I_{C2old} represents the value of the current of the third current source 13. This corresponds to the value of the current that flowed through the second capacitor 8 before the instant of discontinuity. V₁ is the value of the second voltage source 12. This corresponds to the voltage value preset for the first capacitor 3.

The designations for the remaining parameters correspond to the parameters of the system of equations for describing the electric circuit 2.

This system of equations is solvable. The desired solution value is obtained by applying standard solution methods that are known to a person skilled in the art.

The procedure of the method for correctly handling discontinuities during circuit simulation or mixed-signal simulation, as shown by the flowchart 1 in FIG. 1, is explained below with reference to the exemplary embodiment.

In the present example, the electric circuit 2 was generated from an existing network graph.

In the first method step 101, a new graph of the electric circuit 2 was formed which contained the branch of the first voltage source 7.

In the second method step 102, the branch of the first capacitor 3 for which the branch voltage is preset was added to the graph. This branch does not close a loop. Therefore this capacitor is not flagged.

In the third method step 103, the second capacitor 8 is added to the graph. Since this branch closes a loop, the second capacitor 8 is flagged.

In the fifth method step 105, the check did not detect a flagged capacitor for which a value is preset.

In the seventh method step 107, the unflagged first capacitor 3, for which a value is preset, and the flagged second capacitor 8, for which no value is preset, were replaced. On this occasion, the first capacitor 3 was replaced by the second voltage source 12, which injects the preset value for the first capacitor 3, and by the second current source 11, parallel-connected, which injects the value of the current flowing through the first capacitor 3 before the instant of discontinuity.

In the eighth method step 108, no capacitors are replaced.

In the ninth method step 109, the second capacitor 8 was replaced by the third current source 13, which injects the value of the current flowing through the second capacitor 8 before the instant of discontinuity.

In the eleventh method step 111, a DC system of equations is set up for the resulting graph shown in FIG. 3.

The system of equations that can be derived from the modified electric circuit 10 is solvable. Using standard solution methods, it is possible to calculate the initial value of the system of equations in order to calculate the underlying network graph. These are known to one of ordinary skill in the art. The value thus obtained represents a suitable initial value for the network graph underlying the electric circuit 2.

It should also be noted that if values will be preset for both the first capacitor 3 and the second capacitor 8, the second capacitor would nevertheless be flagged and therefore the fifth method step 105 would output the corresponding error message.

I claim:

1. A diagnostic method for correctly handling discontinuities during circuit simulation or mixed-signal simulation, which comprises:
obtaining an image of an electronic circuit including a plurality of elements wherein: the image exists both as a network graph and as a system of differential algebraic equations taking a form of F(x′,x,t)=0, wherein values for voltages present across specific capacitors in the image can be preset, and wherein a further graph can be formed using information from the network graph;
viewing the image at an instant of discontinuity;
forming the further graph to include all branches of voltage sources of the network graph;
successively adding to the further graph a branch of each capacitor in the network graph for which a branch voltage is preset;
checking each capacitor to ascertain whether the branch of the capacitor closes a loop in the further graph and if so flagging the capacitor;
successively adding to the further graph a branch of each capacitor in the network graph for which no branch voltage is preset;
checking each capacitor for which no branch voltage is preset to ascertain whether the branch of the capacitor for which no branch voltage is preset closes a loop in the further graph, and if so, flagging the capacitor for which no branch voltage is preset;
checking whether a capacitor is flagged for which a branch voltage has been preset, and if so, outputting an error message;
replacing each unflagged capacitor, for which a value is preset, by a voltage source for injecting the value that is preset and by a current source configured in parallel with the voltage source, the current source for injecting a value of a current flowing through the unflagged capacitor before the instant of the discontinuity;
replacing each unflagged capacitor, for which a value is not preset, by a voltage source for injecting a value of a branch voltage present before the instant of the discontinuity and by a parallel configured current source for injecting a value of
a current flowing through the unflagged capacitor, for which a value is not preset, before the instant of the discontinuity;
replacing each flagged capacitor by a current source for injecting a value of a current flowing through the flagged capacitor before the instant of discontinuity;
obtaining solution values by setting up and solving DC equations for the further graph; and
transferring the solution values to the network graph.

2. A set of computer-executable instructions for performing a diagnostic method for correctly handling discontinuities during circuit simulation or mixed-signal simulation, the method which comprises:
obtaining an image of an electronic circuit including a plurality of elements wherein: the image exists both as a network graph and as a system of differential algebraic equations taking a form of F(x′,x,t)=0, wherein values for voltages present across specific capacitors in the image can be preset, and wherein a further graph can be formed using information from the network graph;
viewing the image at an instant of discontinuity;
forming the further graph to include all branches of voltage sources of the network graph;
successively adding to the further graph a branch of each capacitor in the network graph for which a branch voltage is preset;
checking each capacitor to ascertain whether the branch of the capacitor closes a loop in the further graph and if so flagging the capacitor;
successively adding to the further graph a branch of each capacitor in the network graph for which no branch voltage is preset;
checking each capacitor for which no branch voltage is preset to ascertain whether the branch of the capacitor for which no branch voltage is preset closes a loop in the further graph, and if so, flagging the capacitor for which no branch voltage is preset;
checking whether a capacitor is flagged for which a branch voltage has been preset, and if so, outputting an error message;
replacing each unflagged capacitor, for which a value is preset, by a voltage source for injecting the value that is preset and by a current source configured in parallel with the voltage source, the current source for injecting a value of a current flowing through the unflagged capacitor before the instant of the discontinuity;
replacing each unflagged capacitor, for which a value is not preset, by a voltage source for injecting a value of a branch voltage present before the instant of the discontinuity and by a parallel configured current source for injecting a value of a current flowing through the unflagged capacitor, for which a value is not preset, before the instant of the discontinuity;
replacing each flagged capacitor by a current source for injecting a value of a current flowing through the flagged capacitor before the instant of discontinuity;
obtaining solution values by setting up and solving DC equations for the further graph; and
transferring the solution values to the network graph.

3. A computer-readable medium having computer-executable instructions for performing a diagnostic method for correctly handling discontinuities during circuit simulation or mixed-signal simulation, the method which comprises:
obtaining an image of an electronic circuit including a plurality of elements wherein: the image exists both as a network graph and as a system of differential algebraic equations taking a form of F(x′,x,t)=0, wherein values for voltages present across specific capacitors in the image can be preset, and wherein a further graph can be formed using information from the network graph;
viewing the image at an instant of discontinuity;
forming the further graph to include all branches of voltage sources of the network graph;
successively adding to the further graph a branch of each capacitor in the network graph for which a branch voltage is preset;
checking each capacitor to ascertain whether the branch of the capacitor closes a loop in the further graph and if so flagging the capacitor;
successively adding to the further graph a branch of each capacitor in the network graph for which no branch voltage is preset;
checking each capacitor for which no branch voltage is preset to ascertain whether the branch of the capacitor for which no branch voltage is preset closes a loop in the further graph, and if so, flagging the capacitor for which no branch voltage is preset;
checking whether a capacitor is flagged for which a branch voltage has been preset, and if so, outputting an error message;
replacing each unflagged capacitor, for which a value is preset, by a voltage source for injecting the value that is preset and by a current source configured in parallel with the voltage source, the current source for injecting a value of a current flowing through the unflagged capacitor before the instant of the discontinuity;
replacing each unflagged capacitor, for which a value is not preset, by a voltage source for injecting a value of a branch voltage present before the instant of the discontinuity and by a parallel configured current source for injecting a value of a current flowing through the unflagged capacitor, for which a value is not preset, before the instant of the discontinuity;
replacing each flagged capacitor by a current source for injecting a value of a current flowing through the flagged capacitor before the instant of discontinuity;
obtaining solution values by setting up and solving DC equations for the further graph; and
transferring the solution values to the network graph.

4. The computer-readable medium according to claim 3, wherein the computer-readable medium is a storage medium.

5. The computer-readable medium according to claim 3, wherein the computer-readable medium is a computer memory.

6. The computer-readable medium according to claim 3, wherein the computer-readable medium is a random-access memory.

7. The computer-readable medium according to claim 3, wherein the computer-readable medium is an electrically transmitted carrier signal.

8. A process which comprises downloading, from an electronic data network to a computer connected to the data network, a set of computer-executable instructions for performing a diagnostic method for correctly handling discontinuities during circuit simulation or mixed-signal simulation, the method including:
obtaining an image of an electronic circuit including a plurality of elements wherein: the image exists both as a network graph and as a system of differential algebraic equations taking a form of F(x′,x,t)=0, wherein values for voltages present across specific capacitors in the image can be preset, and wherein a further graph can be formed using information from the network graph;
viewing the image at an instant of discontinuity;
forming the further graph to include all branches of voltage sources of the network graph;
successively adding to the further graph a branch of each capacitor in the network graph for which a branch voltage is preset;
checking each capacitor to ascertain whether the branch of the capacitor closes a loop in the further graph and if so flagging the capacitor;
successively adding to the further graph a branch of each capacitor in the network graph for which no branch voltage is preset;
checking each capacitor for which no branch voltage is preset to ascertain whether the branch of the capacitor for which no branch voltage is preset closes a loop in the further graph, and if so, flagging the capacitor for which no branch voltage is preset;
checking whether a capacitor is flagged for which a branch voltage has been preset, and if so, outputting an error message;
replacing each unflagged capacitor, for which a value is preset, by a voltage source for injecting the value that is preset and by a current source configured in parallel with the voltage source, the current source for injecting a value of a current flowing through the unflagged capacitor before the instant of the discontinuity;
replacing each unflagged capacitor, for which a value is not preset, by a voltage source for injecting a value of a branch voltage present before the instant of the discontinuity and by a parallel configured current source for injecting a value of a current flowing through the unflagged capacitor, for which a value is not preset, before the instant of the discontinuity;
replacing each flagged capacitor by a current source for injecting a value of a current flowing through the flagged capacitor before the instant of discontinuity;
obtaining solution values by setting up and solving DC equations for the further graph; and
transferring the solution values to the network graph.

9. The process according to claim 8, wherein the data network is an Internet.
